(19) United States
(12) Patent Application Publication
(10) Pub. No.: US 2007/0058289 A1
(43) Pub. Date: Mar. 15, 2007

(54) Media cartridge autoloader

(76) Inventors: Hiromi Tanaka, Tokyo (JP); Paddy Eliot Collins, Colorado Springs, CO (US)

Correspondence Address: ANDERSON, KILL & OLICK, P.C., 1251 AVENUE OF THE AMERICAS, NEW YORK,, NY, 10020-1182, US

(21) Appl. No.: 11/286,238

(22) Filed: Nov. 22, 2005

(30) Foreign Application Priority Data
Sep. 14, 2005 (JP) 2005-267534

(51) Int. Cl. G11B 15/68

(52) U.S. Cl. 360/92

(57) ABSTRACT

A media cartridge autoloader including a media cartridge holding mechanism by which one of media cartridges whose sizes are different is selectively inserted into a media cartridge container is disclosed. When a media cartridge container is used for a media cartridge, a recess formed at an inserting side upper face of the media cartridge moves through a protruding section of a second cartridge holding member. When another media cartridge is inserted, sliding sections of first and second cartridge holding members abut on the other media cartridge and insertion thereof is prevented. When the media cartridge is inserted in a wrong direction, the protruding section abuts on the media cartridge and insertion thereof is prevented. When the media cartridge container is used for the other media cartridge, the first cartridge holding member is attached to a third holding member attaching section of the media cartridge container.

### BACKGROUND OF THE INVENTION

1. Field of the Invention

The present invention relates to a media cartridge autoloader.

2. Description of the Related Art

A typical media cartridge autoloader includes a media cartridge picker in the center, a mail slot at the front side, a read/write media drive at the rear side, and media cartridge transport magazines disposed one at each lateral side.

The media cartridge picker is configured to transport a media cartridge among the mail slot, the media drive, and the media cartridge transport magazines.

Each media cartridge transport magazine comprises one or more media cartridge storage containers that stores the media cartridges therein. A selected one of the media cartridge storage containers is moved next to the media cartridge picker.

Because media cartridges can have different shapes and sizes due to different the recording systems, the media cartridge containers can also be configured differently to accommodate the size, shape and type of media cartridge. When a media cartridge is loaded in the media drive, the media cartridge container is moved and a designated media cartridge is picked.

The media cartridge container to be included in the media cartridge transport magazine is manufactured corresponding to the type of the media cartridge to be used therein. Using different types of media cartridge containers in each media cartridge transport magazine can result in increased manufacturing costs.

### SUMMARY OF THE INVENTION

According to a first aspect of the present invention, there is provided a media cartridge autoloader that includes one or more media cartridge containers each of which may contain an inserted media cartridge, a media cartridge transport magazine which movably holds the plural media cartridge containers, and a media drive into which an arbitrary media cartridge, which is picked from the one or more media cartridges being contained in the one or more media cartridge containers, is moved and loaded. In the media cartridge autoloader, the media cartridge container is formed to provide a space into which any one of the plural media cartridges whose sizes are different can be inserted, and the media cartridge container provides a media cartridge holding mechanism which holds a specific media cartridge of the one or more media cartridges.

According to a second aspect of the present invention, the media cartridge holding mechanism provides a cartridge holding member which is attached to a position abutting different parts in the plural media cartridges, and a media cartridge whose shape is not suitable to the position where the cartridge holding member is attached is prevented from being inserted into the media cartridge container.

According to a third aspect of the present invention, the cartridge holding member is attached to a different position of the media cartridge container corresponding to the shape of a selected media cartridge.

According to a fourth aspect of the present invention, the cartridge holding member includes a first cartridge holding member which holds an upper face of the media cartridge and a second cartridge holding member which holds the upper face and a side face of the media cartridge, and only a media cartridge having a selected shape may be inserted into the media cartridge container by combining the first cartridge holding member and the second cartridge holding member.

According to a fifth aspect of the present invention, the cartridge holding member holds a different type of the one or more media cartridges by changing the position attaching to the media cartridge container.

According to another embodiment of the present invention, since the media cartridge container is formed to provide a space into which any one of the media cartridges whose sizes are different is inserted, and the media cartridge container provides a media cartridge holding mechanism which holds a specific media cartridge of the plural media cartridges; the media cartridge containers, into which the media cartridges whose sizes are different can be inserted, can be used in common, and there is no need to manufacture different types of the media cartridge containers by making the media cartridge containers common for the different types of the media cartridges, and the manufacturing cost can be reduced.

According to yet another embodiment of the present invention, since the media cartridge holding mechanism provides a cartridge holding member which is attached to a position abutting different parts in the media cartridges, and a media cartridge whose shape is not suitable to the position where the cartridge holding member is attached is prevented from being inserted into the media cartridge container, mis-inserting of a different media cartridge into a media cartridge container can be inhibited or prevented. Further, a media cartridge with a wrong orientation can be inhibited or prevented from being inserted.

According to still another embodiment of the present invention, since the cartridge holding member is attached to a different position of the media cartridge container corresponding to the shape of a selected media cartridge, there is no need to manufacture an exclusive cartridge holding member for each media cartridge, the cartridge holding member can be used in common and its manufacturing cost can be reduced.

### BRIEF DESCRIPTION OF TEE DRAWINGS

FIG. 1 is a perspective view illustrating a media cartridge autoloader with an upper cover thereof removed according to a first embodiment of the present invention;

FIG. 2 is a side view illustrating the media cartridge autoloader of FIG. 1 with a side cover thereof removed;

FIG. 3 is a schematic illustration showing operations of a media cartridge picker;

FIG. 4 is a perspective view illustrating a main module;

FIG. 5 is an exploded view illustrating the main module;

FIG. 6 is a perspective view of the main module, viewed from a Y1 side;

FIG. 7 is a perspective view illustrating the media cartridge picker;

FIG. 8 is a perspective view illustrating the media cartridge picker with a pillar and a turntable removed;

FIG. 9 is an exploded perspective view illustrating the media cartridge picker;

FIG. 10 is an exploded perspective view illustrating a turntable lifting mechanism in detail;

FIG. 11 is a perspective view illustrating the turntable;

FIG. 12 is a schematic illustration showing a media cartridge transport mechanism;

FIG. 13 is a perspective view of the main module with the media cartridge picker, a mail slot module, and a motor module removed, viewed from a Y2 side;

FIG. 14 is a perspective view of the main module of FIG. 13, viewed from the Y1 side;

FIG. 15 is a perspective view of a Y2-side part of the main module with the mail slot module removed, viewed obliquely from an X2 side;

FIG. 16 is a perspective view illustrating a media cartridge transport magazine drive with a drive shaft unit located at a home position;

FIG. 17 is a perspective view showing an X1-side portion of the Y2-side part of the main module with the mail slot module removed;

FIG. 18 is a perspective view of the Y2-side part of the main module, viewed obliquely from an X1 side;

FIG. 19 is an enlarged perspective view showing a drive gear and a positioning pin disposed at the X2 side;

FIG. 20 shows a photo sensor for detecting the rotation angle of the turntable;

FIG. 21 is a perspective view of the media cartridge transport magazine with an X2-side lateral plate removed, viewed from the X2 side;

FIG. 22 is a perspective view of the media cartridge transport magazine of FIG. 21, viewed from the X1 side;

FIG. 23 is an enlarged view illustrating a part of the media cartridge transport magazine of FIG. 22;

FIG. 24A illustrates the media cartridge transport magazine drive in its initial state;

FIG. 24B illustrates the media cartridge transport magazine drive in a state to drive an X2-side magazine;

FIG. 24C illustrates the media cartridge transport magazine drive in a state to drive an X1-side magazine;

FIG. 25 illustrates an X2-side part of the drive shaft unit opposing a magazine in the initial state;

FIG. 26 illustrates the X2-side part of the drive shaft unit in a process of being coupled with the magazine;

FIG. 27 illustrates the X2-side part of the drive shaft unit coupled with the magazine;

FIGS. 28A-28D illustrate operations for correcting a center distance between a drive gear and a magazine gear;

FIGS. 29A-29D illustrate operations to be performed when tooth sections of the drive gear contact and interfere with tooth sections of the magazine gear;

FIG. 30 is a flowchart illustrating operations of a microcomputer of a motor control circuit;

FIG. 31 is a perspective view illustrating a configuration of an A type media cartridge;

FIG. 32 is a perspective view illustrating a configuration of a B type media cartridge;

FIGS. 33A-33C illustrate a configuration of a media cartridge container;

FIGS. 34A-34C illustrate a configuration of a first cartridge holding member;

FIGS. 35A-35C illustrate a configuration of a second cartridge holding member;

FIGS. 36A-36C illustrate a configuration of the media cartridge container in which the A type media cartridge can be inserted;

FIG. 37 is a front view of the media cartridge container in a state where the A type media cartridge is inserted;

FIGS. 38A-38C illustrate a configuration of the media cartridge container in which the B type media cartridge can be inserted; and

FIG. 39 is a front view of the media cartridge container in a state where the B type media cartridge is inserted.

### DETAILED DESCRIPTION OF THE PREFERRED EMBODIMENT

An exemplary embodiment of the present invention is described hereinafter with reference to the accompanying drawings.

### First Embodiment

The description of a first embodiment includes the following:

1. Configuration and Operations Overview of Tape Cartridge Autoloader 100

2. Configuration of Main Module 110

3. Configuration and Operations of Tape Cartridge Picker 102

4. Configuration of Tape Cartridge Transport Magazine Drive 300
4-1. Configuration of Drive Shaft Unit 301
4-2. Configuration of Drive Shaft Unit Shift Mechanism 320
4-3. Configuration of Magazine Drive Motor Module 330

5. Configuration of Tape Cartridge Transport Magazines 103, 104

6. operations for Selectively Driving Tape Cartridge Transport Magazines 103, 104

7. Operations of Microcomputer of Motor Control Circuit 410

8. Configuration and Operations of Tape Cartridge Holding Mechanism of Tape Cartridge Container 401

1 [Configuration and Operations Overview of Tape Cartridge Autoloader 100]

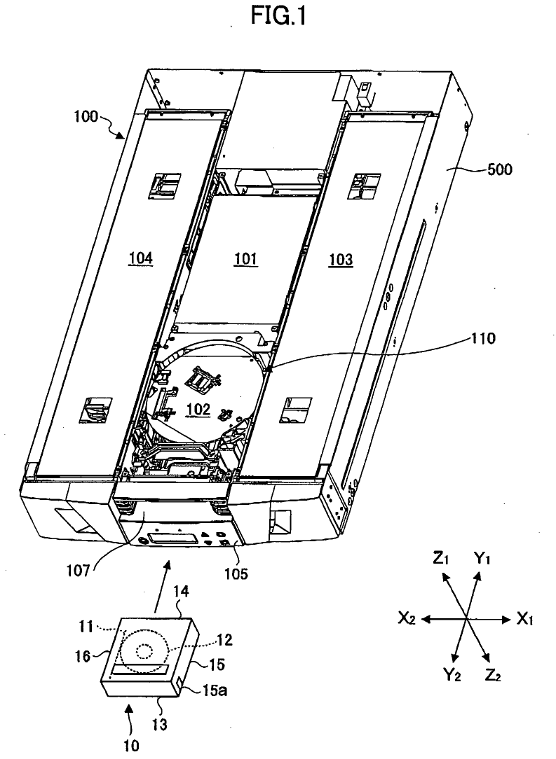

FIG. 1 is a perspective view illustrating a media cartridge autoloader 100 with an upper cover thereof removed according to the first embodiment of the present invention. In the embodiments illustrated in the figures, the media cartridge autoloader is used with one or more tape cartridges, and is therefore referred to as a tape cartridge autoloader. It is recognized, however, that although the following description and the figures provided herein pertain particularly to an autoloader used for tape cartridges, any other suitable type of media cartridge can equally be used with the present invention, such as an optical disk cartridge, as one non-exclusive example. The embodiments disclosed herein are not intended to limit the scope of the present invention in any manner to use with tape cartridges or any other particular type of media. In other words, it is understood that the term “tape” as used herein can equally be substituted for the term “media”.

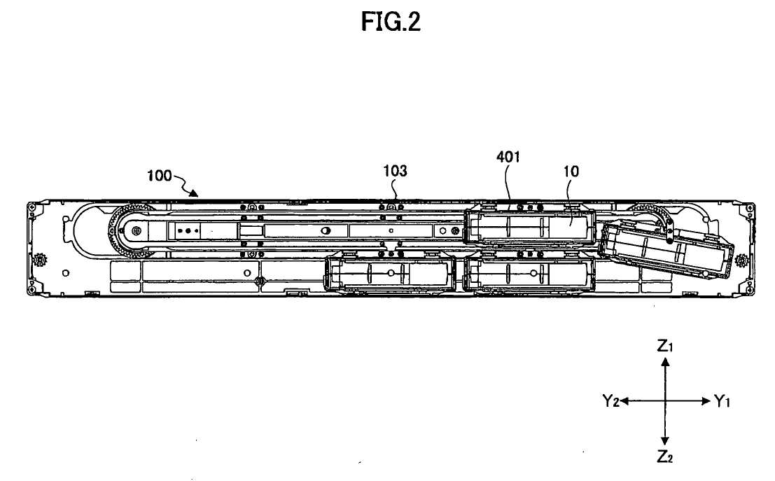

FIG. 2 is a side view illustrating the tape cartridge autoloader 100 with a side cover thereof removed. Throughout the drawings, the width direction is indicated by a line X1-X2, the depth direction is indicated by a line Y1-Y2, and the height direction is indicated by a line Z1-Z2.

In one embodiment, the tape cartridge autoloader 100 generally comprises a metal frame 500, a control panel 105 and a mail slot 107 both on a front panel, a main module 110 including a tape cartridge picker 102 at a position opposing the mail slot 107, a tape drive 101 disposed at the Y1 side of the main module 110, and first and second tape cartridge transport magazines 103 and 104 disposed one at the X1 side and the X2 side of the main module 110. The tape cartridge transport magazines 103 and 104 can be inserted toward the Y1 side from the front panel side and removably attached on opposing sides of the frame 500. It is understood that either tape cartridge transport magazine 103, 104 can be the first tape cartridge transport magazine or the second tape cartridge transport magazine. The tape cartridge autoloader 100 can be mounted in a rack by, for example, fixing four corners of the frame 500 to poles of the rack.

In certain embodiments, the tape cartridge autoloader 100 is designed such that operations of the tape cartridge picker 102 and operations of the tape cartridge transport magazines 103 and 104 do not overlap in terms of time.

A tape cartridge 10 is used in the tape cartridge autoloader 100. Referring to FIG. 1, the tape cartridge 10 includes a magnetic tape 11 wound on a single reel 12 therein such that the magnetic tape 11 is pulled out from a rear face of the tape cartridge 10. The tape cartridge 10 includes a front face 13, a rear face 14, side faces 15 and 16, and a notch 15a formed on the side face 15 which a cartridge pin (described below) engages.

The tape cartridge transport magazines 103 and 104 are each configured to store plural tape cartridges 10 orienting the front faces 13 to face the tape cartridge picker 102. The tape cartridge transport magazines 103 and 104 are also configured to transport the tape cartridges 10 along a racetrack path elongated in the Y1-Y2 direction as shown in FIG. 2.

The tape drive 101 is operable to read and/or write data from or to the magnetic tape 11 pulled out from the loaded tape cartridge 10. The tape drive 101 includes a tape cartridge eject mechanism (not shown). Plural types of tape drives with different heights are available so that one drive is selected from them and attached to the tape cartridge autoloader 100. For this operation, the tape cartridge picker 102 is provided with a turntable lifting mechanism 150 (described below).

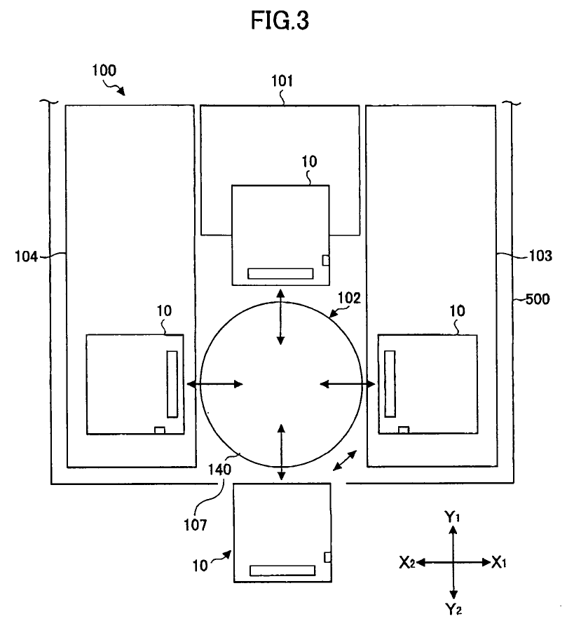

Referring to FIG. 3, the tape cartridge picker 102 is configured to transport the tape cartridge 10 onto or off of a turntable 140 for operations such as loading the tape cartridge 10 inserted through the mail slot 107 into the tape drive 101, retrieving the tape cartridge 10 from one of the tape cartridge transport magazine 103 or 104 to load the tape cartridge 10 onto the tape drive 101, retrieving the tape cartridge 10 from the tape drive 101 to return the tape cartridge 10 to the tape cartridge transport magazine 103 or 104, and ejecting the tape cartridge 10 through the mail slot 107. The tape cartridge picker 102 is also configured to rotate the turntable 140 by a predetermined rotational increment, such as approximately in 90-degree increments, for example, although the predetermined rotational increment can be varied to suit the design requirements of the autoloader. The cartridge picker 102 can also raise/lower the turntable 140, as necessary. When the turntable 140 is rotated, the orientation of the tape cartridge 10 is changed.

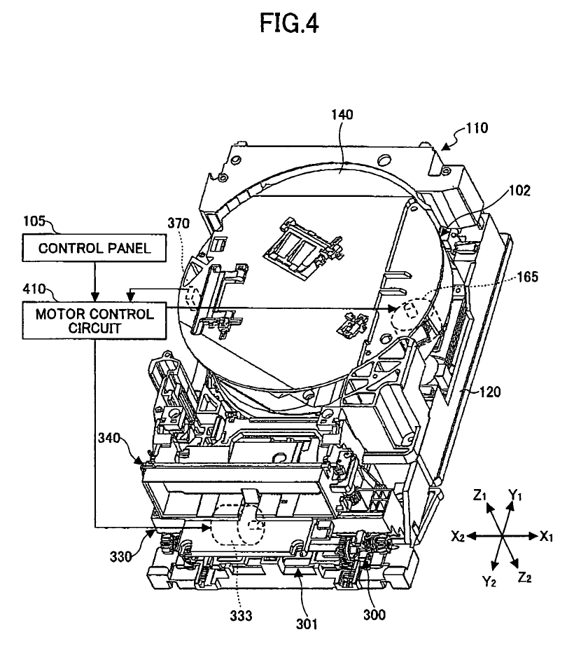

2 [Configuration of Main Module 110] (FIGS. 4-6)

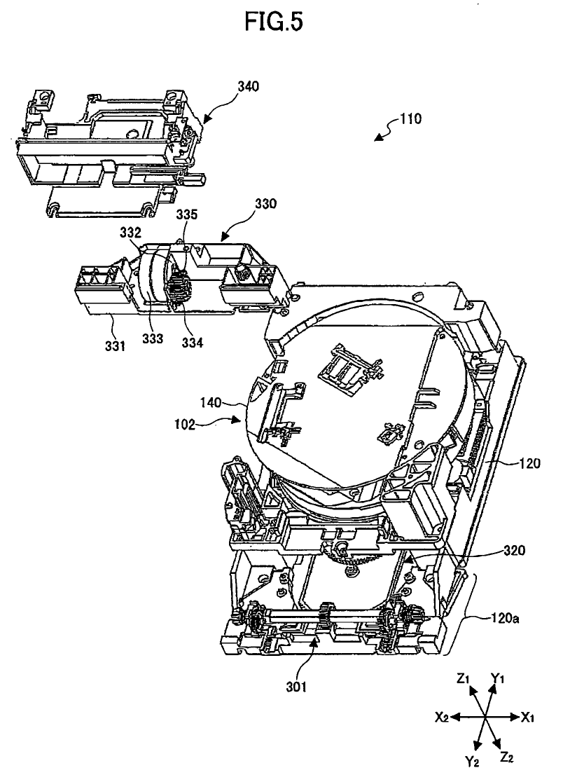

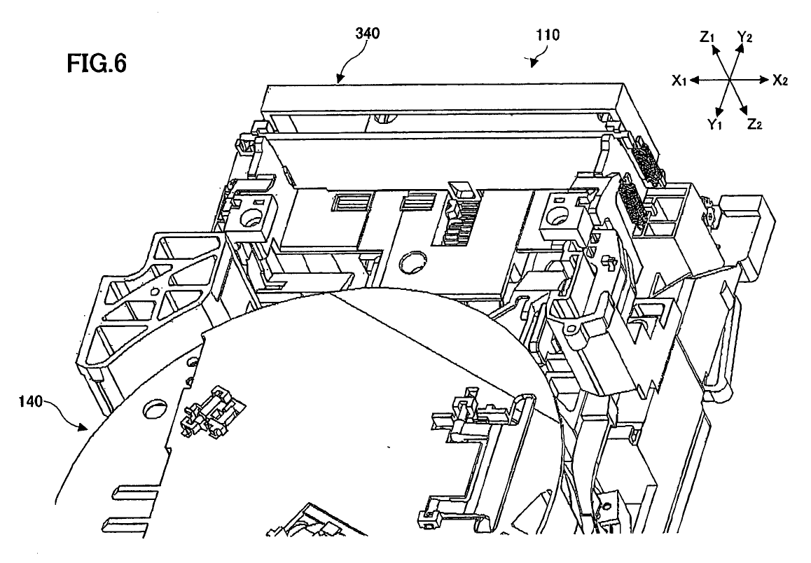

FIG. 4 is a perspective view of the main module 110. FIG. 5 is an exploded view of the main module 110. FIG. 6 is a perspective view of the main module 110, viewed from the Y1 side.

In this embodiment, the main module 110 includes a base 120. The main module 110 also includes the tape cartridge picker 102 and a tape cartridge transport magazine drive 300. The tape cartridge picker 102 can occupy a large part of the base 120. The base 120 includes an extension 120a extending at the Y2 side of the tape cartridge picker 102. A drive shaft unit 301 and a tape cartridge transport magazine drive motor module 330 are disposed on the extension 120a. For example, a mail slot module 340 can be mounted on the upper side of the magazine drive motor module 330. The magazine drive 300 comprises the drive shaft unit 301 and the magazine drive motor module 330 as described below.

A motor control circuit 410 shown in FIG. 4 drives, in response to a command generated when a user operates the control panel 105, a stepping motor 165 and a magazine drive motor 333 in a manner described below while monitoring signals from a photo sensor 370.

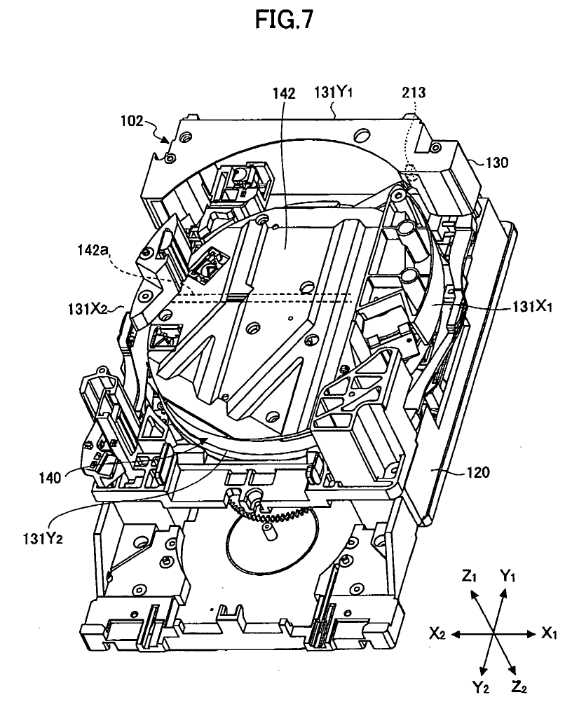

3 [Configuration and Operations of Tape Cartridge Picker 102] (FIGS. 7-12)

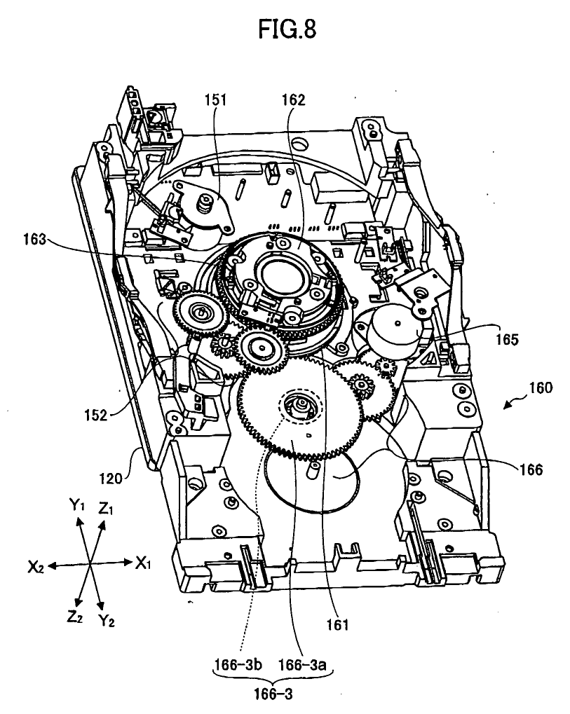

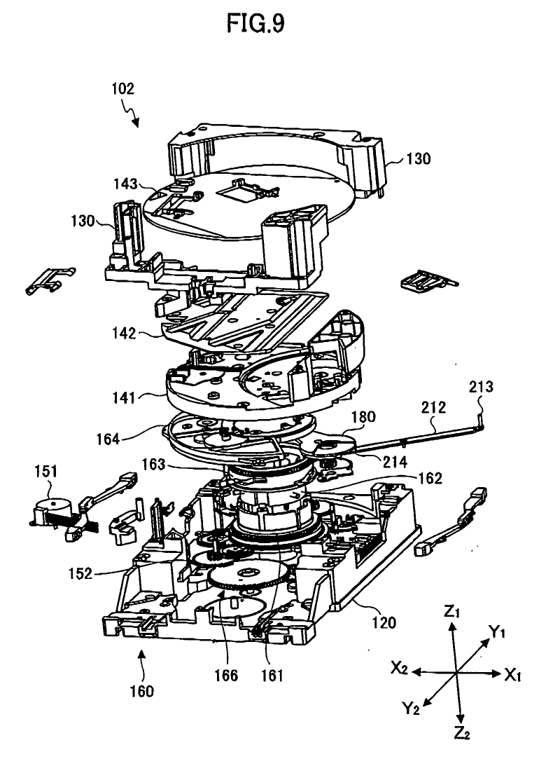

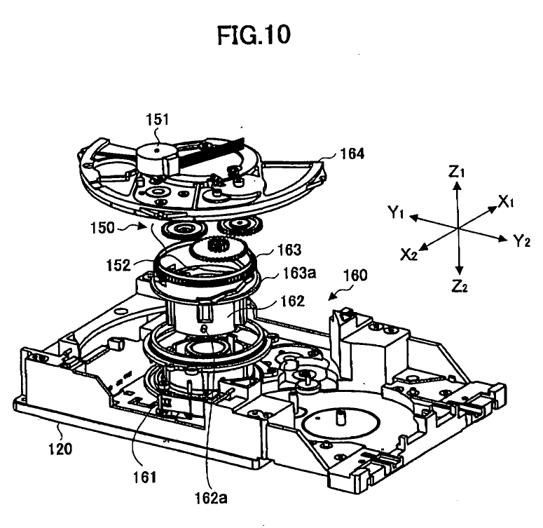

FIG. 7 illustrates the tape cartridge picker 102 with an upper plate 143 of the turntable 140 removed. FIG. 8 illustrates the tape cartridge picker 102 with a pillar 130 and the turntable 140 removed. FIG. 9 is an exploded perspective view illustrating the tape cartridge picker 102. FIG. 10 illustrates the turntable lifting mechanism 150 in detail.

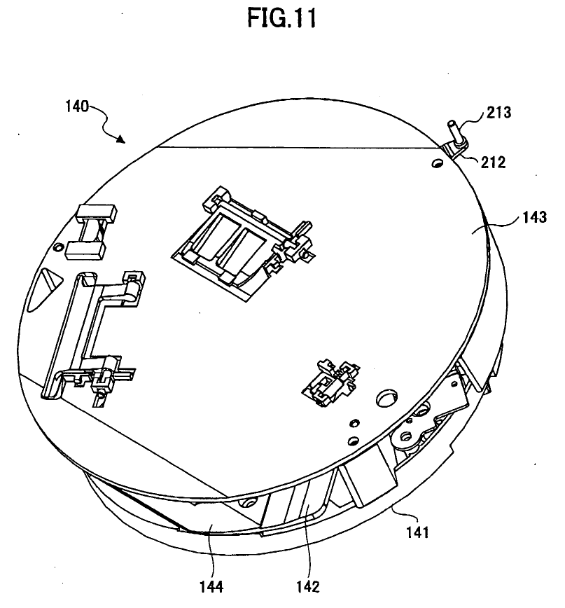

The tape cartridge picker 102 includes the pillar 130 mounted on the base 120, the turntable 140 (FIG. 11) configured to support the tape cartridge 10, the turntable lifting mechanism 150 (FIG. 10) configured to slightly raise and lower the turntable 140 for height position adjustment, and a turntable rotating mechanism 160 configured to rotate the turntable 140 at a predetermined rotational increment, such as approximately in 90-degree increments, for example. The tape cartridge picker 102 has ports 131X1, 131X2, 131Y1, and 131Y2 on four sides thereof (see FIG. 7).

A rotating ring gear 161, a cylindrical stand 162, a lifting ring gear 163, and a sub base 164 are disposed on the base 120. The rotating ring gear 161 is rotatably attached on the base 120. The cylindrical stand 162 is arranged at the inner side of the rotating ring gear 161 and the lifting ring gear 163 so as to be rotated along with the rotating ring gear 161 and be raised independently from the rotating ring gear 161. The lifting ring gear 163 is arranged at the upper side of the rotating ring gear 161 so as to be rotated independently from the rotating ring gear 161. A boss 162a (FIG. 10) of the cylindrical stand 162 is configured to engage a diagonal groove 163a of the lifting ring gear 163. The cylindrical stand 162 is rotated by rotation of the rotating ring gear 161, and raised/lowered by rotation of the lifting ring gear 163. The sub base 164 is a semi-circular plate fixed to a position slightly separated from and at the upper side of the base 120.

Referring to FIG. 11, the turntable 140 includes a base plate 141, a floor plate 142, the upper plate 143, and a clearance 144 between the floor plate 142 and the upper plate 143 to receive the tape cartridge 10. The base plate 141 is screwed onto the cylindrical stand 162 (FIG. 10).

Referring to FIG. 10, the turntable lifting mechanism 150 includes a stepping motor 151, a gear train 152, and the lifting ring gear 163. Both the stepping motor 151 and the gear train 152 are provided on the base plate 141.

As shown in FIG. 8, the turntable rotating mechanism 160 includes a stepping motor 165, a reduction gear train 166, and the rotating ring gear 161, all of which are provided on the sub base 164 (FIG. 9). A two-stage gear 166-3, which is the last stage gear of the reduction gear train 166, comprises a large-diameter gear section 166-3a and a small-diameter gear section 166-3b.

The turntable lifting mechanism 150 has a function of initializing the turntable 140 by raising/lowering the turntable 140 to a home position thereof in the Z direction. The turntable rotating mechanism 160 has a function of initializing the turntable 140 by rotating the turntable 140 to the home position in the rotation direction. The home position of the turntable 140 is a position where a y-axis (described later) becomes parallel to the Y-axis.

The lifting mechanism initialization operation and the turntable rotating mechanism initialization operation apply a method of moving an object to an operation end position defined as a reference position, and then moving the object back by a predetermined distance. The same method is applied to operations for initializing a tape cartridge transport mechanism 170 (described below).

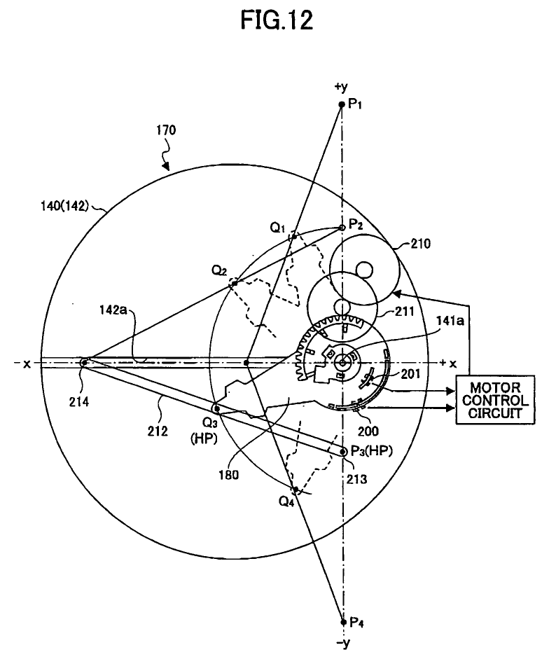

Referring to FIG. 10, the turntable 140 includes the base plate 141, the floor plate 142, the upper plate 143, and the clearance 144 between the floor plate 142 and the upper plate 143 to receive the tape cartridge 10. Referring to FIG. 12, the turntable 140 has coordinates applied wherein the position of a pin 141a (to be described below) is defined as the origin, a guide groove 142a (to be described below) is defined as an x-axis, and an axis passing through the origin and being orthogonal to the x-axis is defined as a y-axis.

The tape cartridge transport mechanism 170 and a stepping motor 210 (described later), both shown in FIG. 12, are provided on the base plate 141 (FIG. 11).

In one embodiment, the tape cartridge transport mechanism 170 has a function of linearly moving the tape cartridge 10 between a position on the turntable 140, i.e., a position inside the clearance 144, and a position outside the tape cartridge picker 102. Alternatively, the tape cartridge transport mechanism 170 can move the tape cartridge 10 in a non-linear manner, or can combine linear and non-linear movements of the tape cartridge 10. The tape cartridge transport mechanism 170 includes a rotary arm 180 rotatably attached to the pin 141a formed on the base plate 141, the stepping motor 210 (FIG. 12) configured to reciprocally rotate the rotary arm 1B0 between positions Q1 and Q4 within a predetermined angular range, a reduction gear mechanism 211 configured to transmit the rotation of the motor 210 at a reduced rotation rate to the rotary arm 180, and a lever 212 with a center part rotatably connected to a tip end of the rotary arm 190. A cartridge pin 213 is vertically fixed to an end of the lever 212, while a pin 214 is fixed to the other end of the lever 212. The pin 214 engages the guide groove 142a formed on a lower face of the floor plate 142.

In one embodiment, the turntable rotating mechanism 160 can rotate the turntable 140 in approximately 90-degree increments, for example, in the clockwise direction or the counterclockwise direction with respect to the home position such that the orientation of the tape cartridge 10 is changed. In non-exclusive alternative embodiments, the turntable can be rotated greater than or less than 90 degrees in either direction. The tape cartridge transport mechanism 170 retrieves the tape cartridge 10 and transports it onto and off of the turntable 140 (see FIG. 3) while the cartridge pin 213 is engaged in the notch 15a of the tape cartridge 10 (FIG. 1).

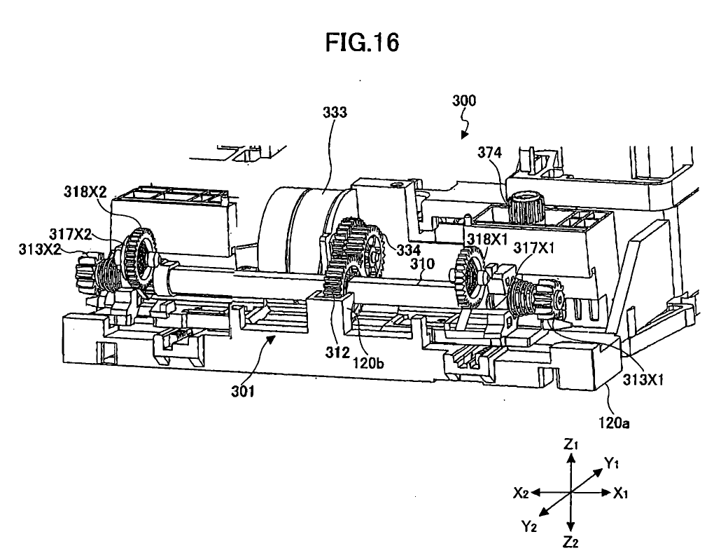

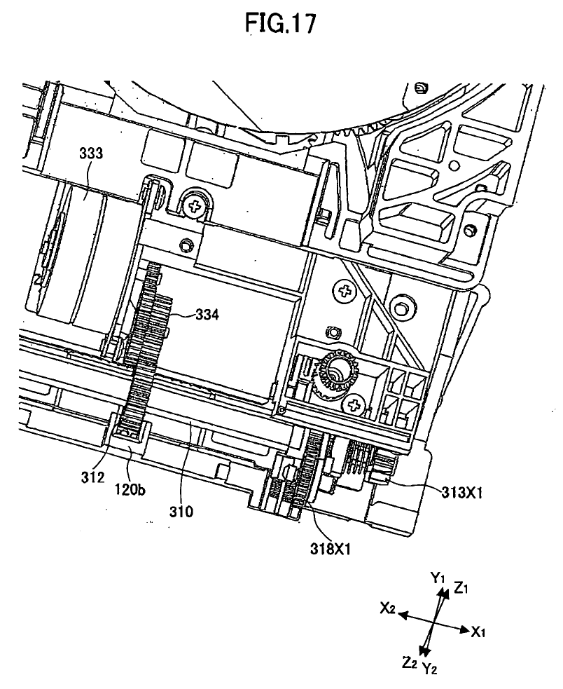

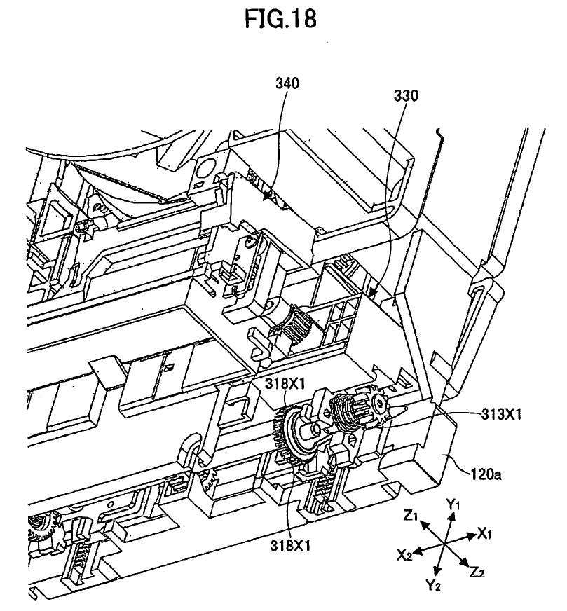

4 [configuration of Tape Cartridge Transport Magazine Drive 300] (FIGS. 4-6, FIGS. 13-20)

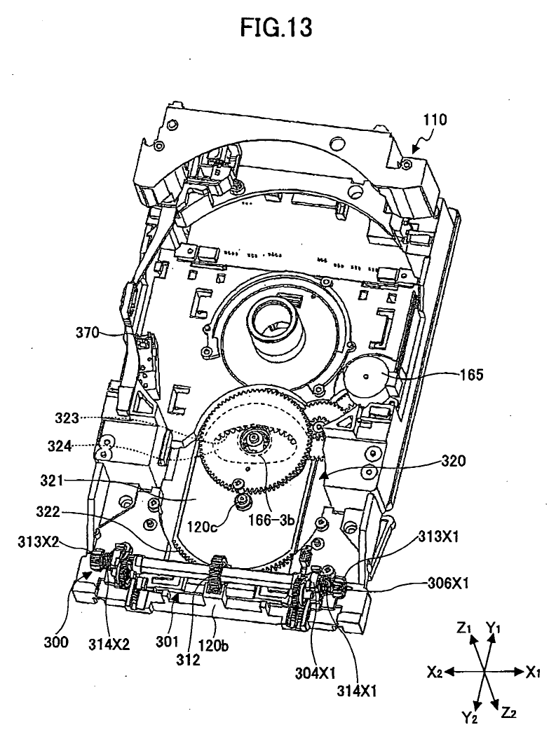

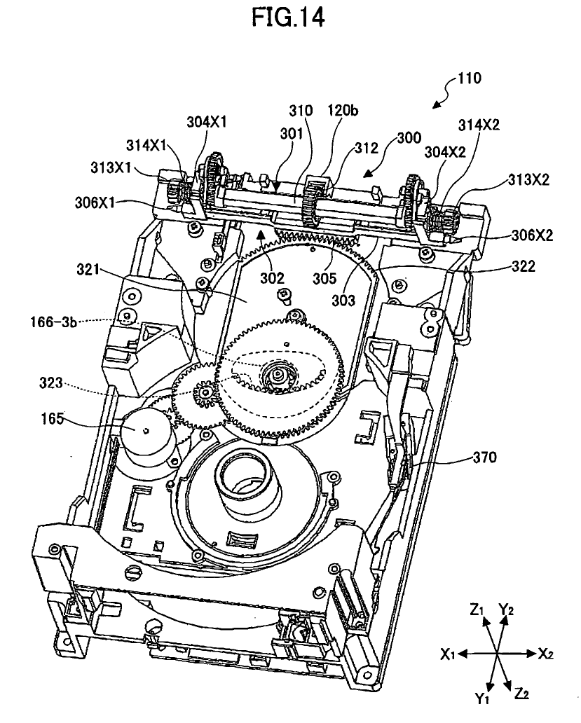

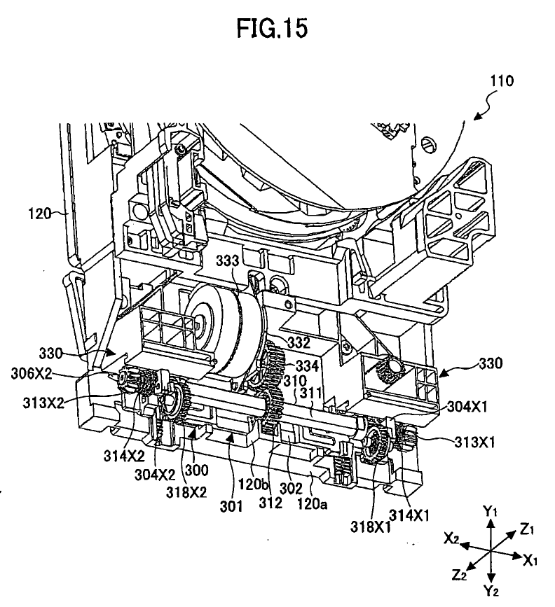

FIG. 13 is a perspective view of the main module 110 with the tape cartridge picker 102, the mail slot module 340, and the motor module 330 removed, viewed from the Y2 side. FIG. 14 is a perspective view of the main module 110 of FIG. 13, viewed from the Y1 side. FIG. 15 is a perspective view of a Y2-side part of the main module 110 with the mail slot module 340 removed.

With reference to FIGS. 4, 5, and 13-15, the tape cartridge transport magazine drive 300 comprises the drive shaft unit 301, the drive shaft unit shift mechanism 320, and the magazine drive motor module 330.

4-1 [Configuration of Drive Shaft Unit 301]

Referring to FIGS. 5, 6, and 13-18, the drive shaft unit 301 comprises a frame 302, a drive shaft 310, a center gear 312, drive gears 313X1 and 313X2 disposed one on each end of the drive shaft 310, and is installed on the base 120 movably in the X1-X2 direction. FIGS. 5, 6, and 13-18 show the drive shaft unit 301 located at its home position.

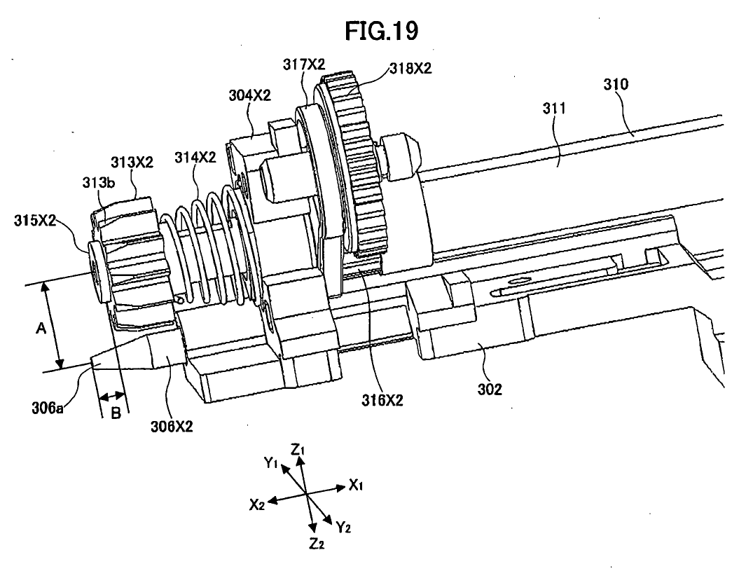

The frame 302 (FIG. 15) comprises a frame main body 303 (FIG. 14) elongated in the X1-X2 direction, flanges 304X1 and 304X2 formed one at each end of the frame main body 303, a rack 305 (FIG. 14) at the center of the frame main body 303, and positioning pins 306X1 and 306X2 provided one on each end of the frame main body 303. Each of the positioning pins 306X1 and 306X2 includes a conical section 306a (FIG. 19). The frame 302 is disposed on the extension 120a of the base 120 movably in the X1-X2 direction.

The drive shaft 310 is rotatably supported at both ends by the flanges 304X1 and 304X2. Gears 316X1 and 316X2 (FIG. 19) are secured to the drive shaft 310 at the inner side of the flanges 304X1 and 304X2. The gears 316X1 and 316X2 prevent the drive shaft 310 from moving with respect to the flanges 304X1 and 304X2 in the X1-X2 direction. The drive shaft 310 has a flat face 311 in its diametrical direction at least at the center and ends thereof so as to have a D-shaped cross section, on which the center gear 312 fits. The drive shaft 310 is configured to rotate with the center gear 312 and is movable in the X1-X2 direction with respect to the center gear 312. In one embodiment, as the center gear 312 is fitted in a holder section 120b formed integrally on the base 120, the movement of the center gear 312 in the X1-X2 direction is restricted.

The drive gears 313X1 and 313X2 are attached to the drive shaft 310 at the outer side of the flanges 304X1 and 304X2, respectively. The drive gears 313X1 and 313X2 are configured to rotate with the drive shaft 310, and are slidable along the drive shaft 310 in the axial direction of the drive shaft 310. Washers 315X2 (FIG. 19) can be threaded on the end faces of the drive shaft 310 to prevent the drive gears 313X1 and 313X2 from dropping off. Compression coil springs 314X1 and 314X2 are wound around the drive shaft 310 between the drive gears 313X1, 313X2 and the flanges 304X1, 304X2, respectively. The drive gear 313X2 compresses the compression coil spring 314X2 to move in the X1 direction when a force in the X1 direction is applied to the drive gear 313X2. The drive gear 313X1 compresses the compression coil spring 314X1 to move in the X2 direction when a force in the X2 direction is applied to the drive gear 313X1.

As shown in detail in FIG. 19, there is a distance A between the positioning pin 306X2 and the drive shaft 310. The positioning pin 306X2 extends further outward than the drive gear 313X2 by a distance B. The drive gear 313X2 is a spur gear having a tapered face 313b on the outer end. The drive gears 313X1 and the positioning pin 306X1 also have the configurations as described above.

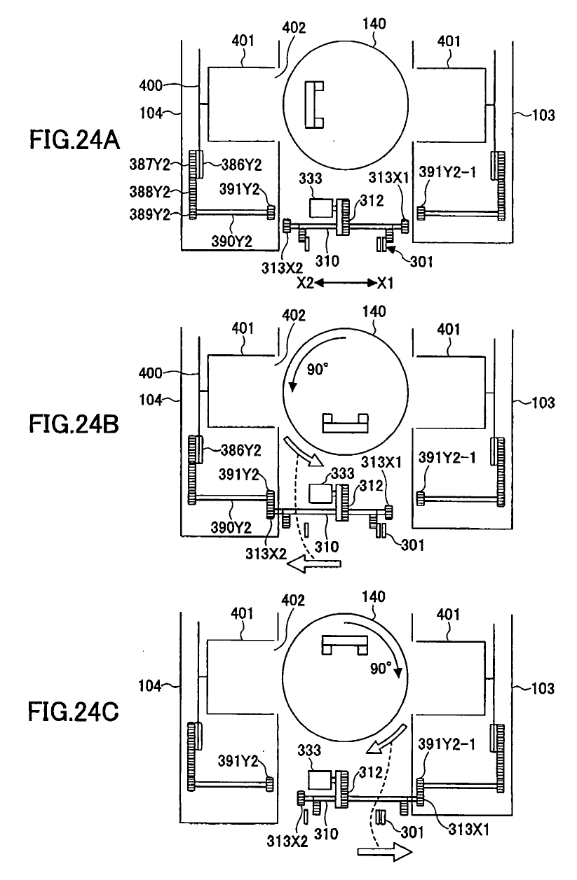

The drive shaft unit 301 is usually located at a home (center) position shown in FIGS. 4 and 24A. When the drive shaft unit 301 is at the home position, the drive gears 313X1 and 313X2, the positioning pins 306X1 and 306X2 are located within the width of the base 120 in the X1-X2 direction.

Swing arms 317X1 and 317X2 are attached to the drive shaft 310 between the gears 316X1, 316X2 and the flanges 304X1, 304X2, respectively. Gears 318X1 and 318X2 are attached to ends of the swing arms 317X1 and 317X2. The gears 318X1 and 318X2 mesh with the gears 316X1 and 316X2, respectively. The swing arms 317X1 and 317X2 swing in the same direction as the drive shaft 310 rotates.

4-2 [Configuration of Drive Shaft Unit Shift Mechanism 320]

The drive shaft unit shift mechanism 320 utilizes the stepping motor 165 that rotates the turntable 140. The drive shaft unit shift mechanism 320 comprises the stepping motor 165 and a gear member 321 (see FIGS. 13 and 14).

The gear member 321 has a generally elliptical shape, comprising an outer gear section 322 and an inner gear section 323 along the edge of an inner opening 324. A center hole of the gear member 321 fits on a shaft portion 120c of the base 120. The inner gear section 323 engages a small-diameter gear section 166-3b, while the outer gear section 322 engages the rack 305 (FIG. 14).

When the stepping motor 165 is driven, the turntable 140 is rotated through the gear train 166. At the same time, the gear member 321 is rotated thought the small-diameter section 166-3b in the clockwise direction or the counterclockwise direction in accordance with the rotational direction of the stepping motor 165, so that the drive shaft unit 301 is moved through the rack 305 in the X2 direction or the X1 direction.

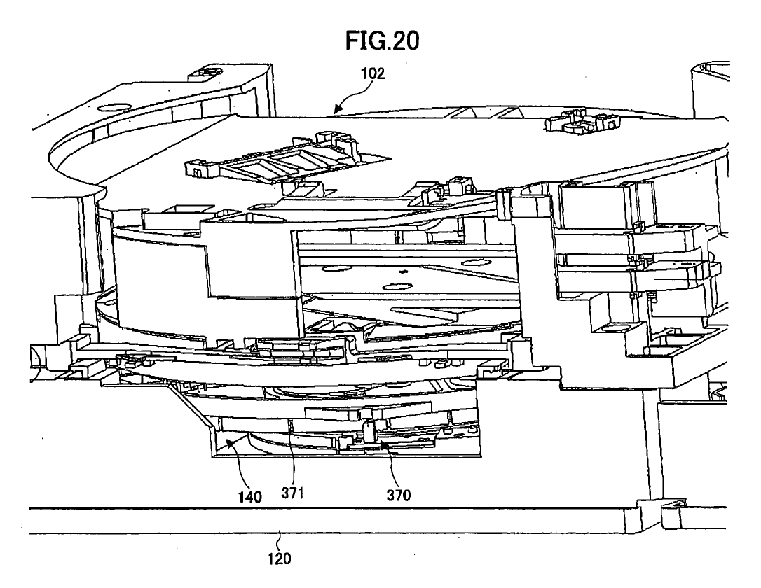

Referring to FIG. 20, the photo sensor 370 for detecting the rotating angle of the turntable 140 is provided. The photo sensor 370 detects the rotating angle of the turntable 140 by detecting slits 371, which can be formed in a predetermined arrangement on a rib around a lower face of the turntable 140. In one embodiment, the rotating angle of the turntable 140 and the moving distance of the drive shaft unit 301 can have the following relation: When the rotating angle of the turntable 140 is approximately 15 degrees, the moving distance of the drive shaft unit 301 is approximately 2.5 mm; when the rotating angle of the turntable 140 is approximately 30 degrees, the moving distance of the drive shaft unit 301 is approximately 5 mm; and when the rotating angle of the turntable 140 is approximately 90 degrees, the moving distance of the drive shaft unit 301 is approximately 15 mm. However, it is recognized that other suitable arrangements can be utilized with the present invention depending upon the design requirements of the autoloader.

4-3 [Configuration of Magazine Drive Motor Module 330]

As shown in FIG. 5, in the magazine drive motor module 330, the magazine drive motor 333 is secured to a flange section 332 of a frame 331. A reduction gear 334 is held in the flange section 332. The reduction gear 334 engages a gear 335 secured to a spindle of the magazine drive motor 333.

The magazine drive motor module 330 is secured to the Y1-side end of the base 120 such that the reduction gear 334 engages the gear 312 as shown in FIG. 15.

When the magazine drive motor 333 is driven, the gear 312 is rotated through the reduction gear 334. Accordingly, the drive shaft 310 and the drive gears 313X1 and 313X2 are rotated.

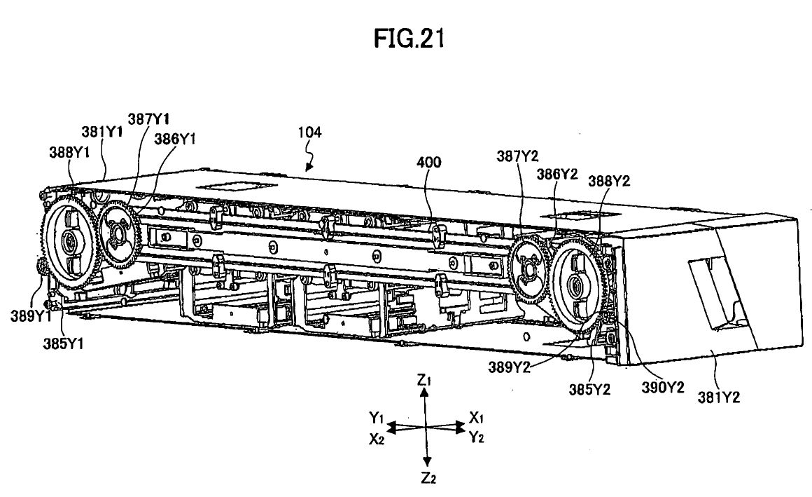

5 [Configuration of Tape Cartridge Transport Magazines 103, 104] (FIGS. 21-23)

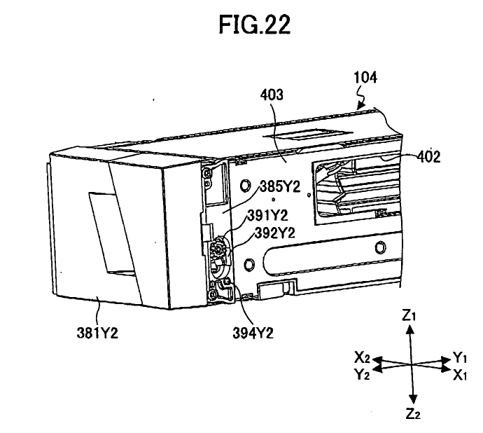

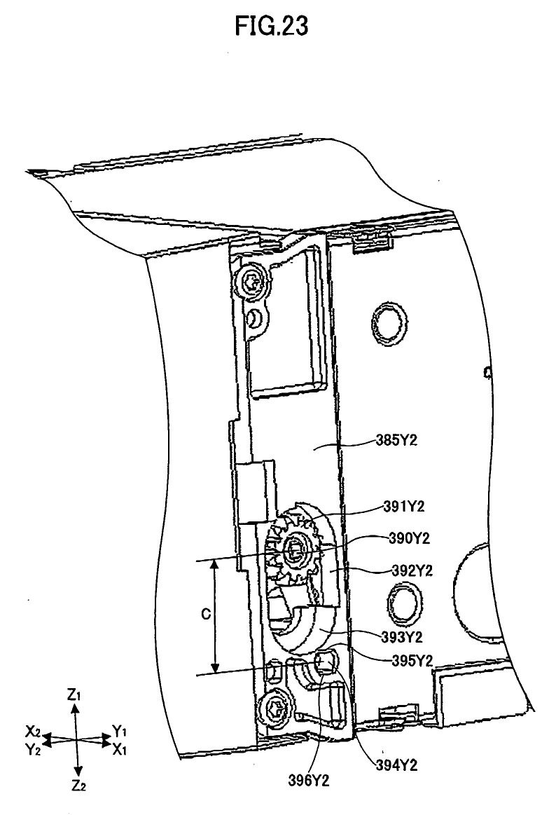

FIG. 21 is a perspective view of the tape cartridge transport magazine 104 with an X2-side lateral plate removed, viewed from the X2 side. FIG. 22 is a perspective view of the tape cartridge transport magazine 104 of FIG. 21, viewed from the X1 side. FIG. 23 is an enlarged view illustrating a part of the tape cartridge transport magazine 104 of FIG. 22.

Referring to FIG. 21, the tape cartridge transport magazine 104 is a quadrangular prism elongated in the Y1-Y2 direction and comprises decorative panels 381Y1 and 381Y2 at opposing ends in the longitudinal direction. In one embodiment, the tape cartridge transport magazine 104 can be installable at both the X1 side and the X2 side of the main module 110 by reversing the longitudinal orientation without turning it upside down. Alternatively, the tape cartridge transport magazine 104 can be positioned and/or oriented differently relative to the main module 110.

As shown in FIG. 21, a frame 385Y2, a pulley 386Y2, a large-diameter gear member 388Y2 that engages a gear section 387Y2 provided at the end of the pulley 386Y2, and a small-diameter gear member 389Y2 that engages the large-diameter gear member 388Y2 are provided at the Y2 side. The small-diameter gear member 389Y2 is secured to an end of a rotary shaft 390Y2.

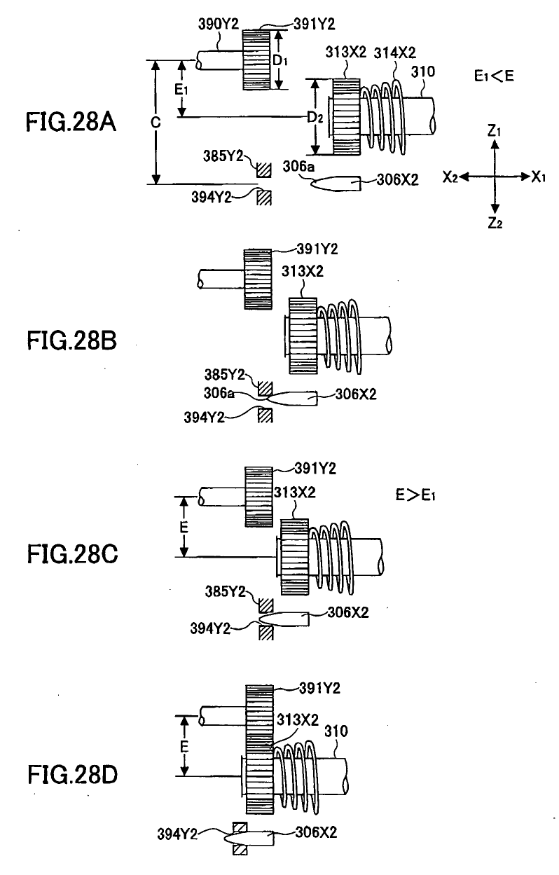

As shown in FIGS. 22 and 23, a small-diameter magazine gear 391Y2 is secured to the opposite end of the rotary shaft 390Y2. An opening 392Y2 elongated in the Z direction is formed in the frame 385Y2. The magazine gear 391Y2 is exposed from a Z1-side part of the opening 392Y2. The opening 392Y2 includes an opening portion 393Y2 having a size that allows the drive gear 313X2 to be fitted therein. A positioning hole 394Y2 is formed at the Z2 side of the opening portion 393Y2 in the frame 385Y2. The positioning hole 394Y2 is elongated in the Y1-Y2 direction and includes linear edges 395Y2 and 396Y2 at the Z1 side and the Z2 side, each extending in the Y1-Y2 direction. The positioning hole 394Y2 is formed at the Z2 side of the magazine gear 391Y2 with a distance C therebetween (see FIG. 28A). The distance C is determined based on the distance A, a pitch circle diameter D1 of the magazine gear 391Y2, and a pitch circle diameter D2 of the drive gear 313X2 such that the center distance between the magazine gear 391Y2 and the drive gear 313X2 is set to an appropriate value E when the positioning pin 306X2 is fitted in the positioning hole 394Y2 (see FIGS. 28A and 28D), Referring back to FIG. 21, a frame 385Y1, a pulley 386Y1, a gear section 387Y1, a large-diameter gear member 388Y1, a small-diameter gear member 389Y1, and a magazine gear are provided at the Y1 side similar to the Y2 side.

Plural tape cartridge containers 401 are disposed at even intervals on a belt 400 extending around the pulleys 386Y1 and 386Y2 (see FIGS. 2 and 21).

An opening 402 (FIG. 22) having a size corresponding to the tape cartridge 10 is formed in an X1-side lateral plate 403 of the tape cartridge transport magazine 104 so as to oppose the tape cartridge picker 102 when the tape cartridge transport magazine 104 is mounted. Also, openings (not shown) for inserting tape cartridges 10 are formed in the lateral plate 403 of the tape cartridge transport magazine 104 so as to oppose the corresponding tape cartridge containers 401 (FIG. 2).

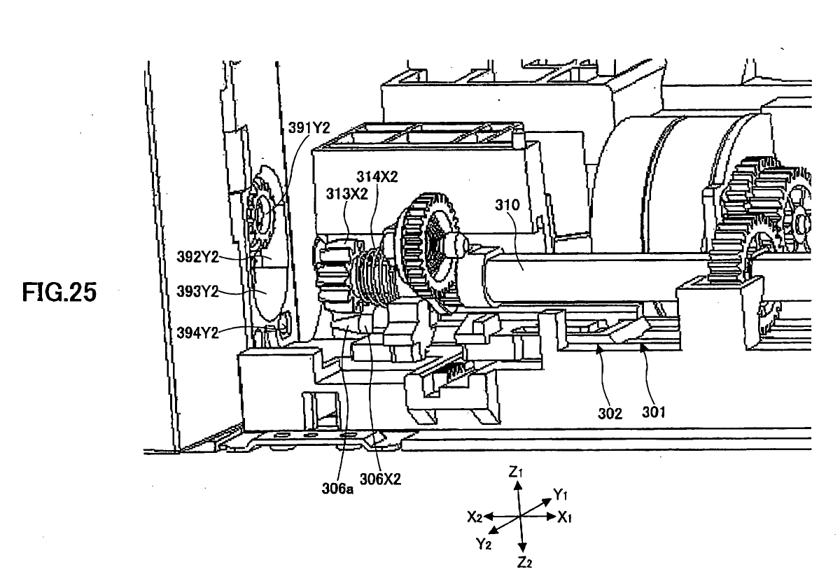

When the tape cartridge transport magazines 103 and 104 are attached at the X1 side and the X2 side as shown in FIG. 1, the drive shaft unit 301 can be located at the home position shown in FIG. 24A. At the X2 side, as shown in FIG. 25, the magazine gear 391Y2, the opening 392Y2, and the positioning hole 394Y2 oppose the drive gear 313X2 (313X1) and the positioning pin 306X2 (306X1). The opening 402 opposes the tape cartridge picker 102.

6 [Operations for Selectively Driving Tape Cartridge Transport Magazines 103, 104] (FIGS. 24A-29D)

FIG. 24B shows a state to drive the tape cartridge transport magazine 104. FIG. 24C shows a state to drive the tape cartridge transport magazine 103.

When a command to drive the tape cartridge transport magazine 104 is input, the stepping motor 165 is driven in the normal direction by the motor control circuit 410 so as to drive the magazine drive motor 333 (see FIG. 4).

When the stepping motor 165 is driven, the turntable 140 is rotated in the counterclockwise direction through the reduction gear train 166 (FIG. 9). At the same time, the drive shaft unit 301 is driven in the X2 direction through the gear member 321 (FIG. 13) and the rack 305. The stepping motor 165 is stopped at the time when the photo sensor 370 (FIG. 20) detects that the turntable 140 is rotated by a predetermined amount, such as by approximately 90 degrees in the counterclockwise direction. The drive shaft unit 301 is moved in the X2 direction, so the drive gear 313X2 is inserted into the opening portion 393Y2 to mesh with the magazine gear 391Y2. Thus, the magazine drive 300 establishes a rotation transmission path from the magazine drive motor 333 to the tape cartridge transport magazine 104.

The stepping motor 165 for rotating the turntable 140 is also used for moving the drive shaft unit 301. Therefore, there is no need to provide a stepping motor exclusively used for moving the drive shaft unit 301. It is so designed that the tape cartridge picker 102 is at rest while the tape cartridge transport magazine 104 is driven. According to the present embodiment, a part of the resting tape cartridge picker 102 is operated for moving the drive shaft unit 301.

As the drive shaft unit 301 is interlocked with the turntable 140, the moving distance of the drive shaft unit 301 is found by detecting the rotating angle of the turntable 140. Therefore, there is no need to provide the drive shaft unit 301 with a mechanism for detecting the moving distance.

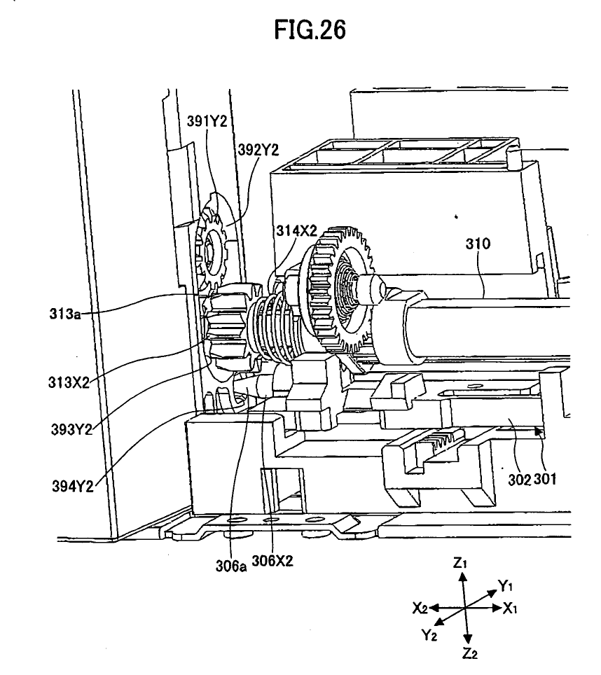

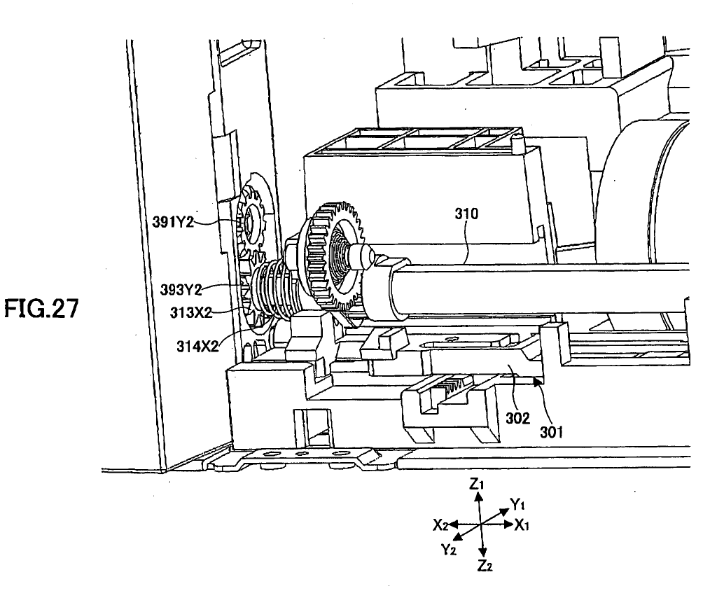

At the final stage of the movement of the drive shaft unit 301 in the X2 direction, the following operations illustrated in FIGS. 26 and 27 are performed.

Just before the drive gear 313X2 contacts the magazine gear 391Y2, the positioning pin 306X2 fits into the positioning hole 394Y2 (see FIGS. 26, 28B, and 28C) so as to set the center distance between the magazine gear 391Y2 and the drive gear 313X2 to the appropriate value E. When the drive shaft unit 301 is further moved in the X2 direction to be inserted into the opening portion 393Y2 from the lateral side thereof, tooth sections of the drive gear 313X2 fit into tooth groove sections of the magazine gear 391Y2 (see FIGS. 27, 24B, and 28B). Thus, the drive gear 313X2 correctly engages the magazine gear 391Y2. The tapered face 313b helps the drive gear 313X2 to smoothly mesh with the magazine gear 391Y2.

FIGS. 28A-28D illustrate operations for correcting the center distance between the drive gear 313X2 and the magazine gear 391Y2 to the appropriate value E when the drive gear 313X2 engages the magazine gear 391Y2.

FIG. 28A illustrates the magazine gear 391Y2 and the drive gear 313X2 located at the positions shown in FIGS. 24A and 25. Supposing that the center distance between the magazine gear 391Y2 and the drive gear 313X2 is a value E1 smaller than the appropriate value E. This situation may occur when, for example, the frame 500 is distorted at the time of mounting the tape cartridge autoloader 100 on the rack or when there is an assembly incorrect in the tape cartridge autoloader 100.

When the drive shaft unit 301 is moved in the X2 direction, a tip end of the conical section 306a of the positioning pin 306X2 is inserted into the positioning hole 394Y2 as shown in FIG. 28B and further inserted as shown in FIG. 28C before the drive gear 313X2 reaches the magazine gear 391Y2. During this process, the drive gear 313X2 is slightly moved in the Z2 direction or the tape cartridge transport magazine 104 is slightly moved in the Z1 direction, so that the center distance between the magazine gear 391Y2 and the drive gear 313X2 is corrected to the appropriate value E. After the center distance is corrected to the appropriate value E, as shown in FIG. 28D, the drive gear 313X2 correctly engages the magazine gear 391Y2.

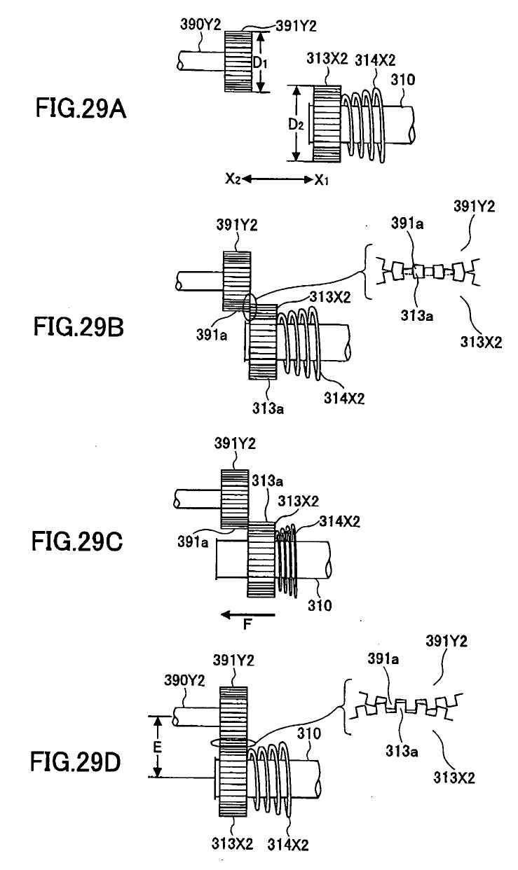

FIGS. 29A-29D illustrate operations for locating the drive gear 313X2 to correctly mesh with the magazine gear 391Y2 when the tooth sections of the drive gear 313X2 contact and interfere with tooth sections of the magazine gear 391Y2.

FIG. 29B illustrates the tooth sections of the drive gear 313X2, which are moved in the X2 direction from the original position shown in FIG. 29A, contacting and interfering with the tooth sections of the magazine gear 391Y2.

When the drive shaft unit 301 is further moved in the X2 direction, the compression coil spring 314X2 is compressed as shown in FIG. 29C. Thus, the drive shaft unit 301 is moved to the final position. The drive gear 313X2 is stopped with lateral end faces of the tooth sections 313a abutting opposing lateral end faces of the tooth section 391a of the magazine gear 391Y2.

Then, the magazine drive motor 333 is started as described below, and accordingly the drive gear 313X2 is rotated. When the tooth sections of the rotating drive gear 313X2 oppose the tooth groove sections of the magazine gear 391Y2, the drive gear 313X2 is moved in the X2 direction with a spring force F of the compression coil spring 314X2 so as to correctly mesh with the magazine gear 391Y2 as shown in FIG. 29D.

After the drive gear 313X2 engages the magazine gear 391Y2, the gear 312 is rotated by the magazine drive motor 333 through the reduction gear 334. Accordingly, the drive shaft 310, the drive gears 313X1 and 313X2 are rotated. The rotation of the drive gear 313X2 is transmitted to the magazine gear 391Y2, the large-diameter gear member 388Y2, the gear section 387Y2, and to the pulley 386Y2 (FIG. 24A). Thus, the belt 400 is driven so as to move and/or position the tape cartridge containers 401 together with the tape cartridges 10 stored in the tape cartridge containers 401.

When a command to stop driving the tape cartridge transport magazine 104 is input, the magazine drive motor 333 is stopped. Then, the stepping motor 165 is driven in the reverse direction to rotate the turntable 140 back to the home position. Also, the drive shaft unit 301 is moved through the gear member 321 and the rack 305 in the X1 direction back to the home position shown in FIG. 24A.

If a command to drive the tape cartridge transport magazine 103 is input when the drive shaft unit 301 is located at the home position shown in FIG. 24A, the stepping motor 165 is driven in the reverse direction by the motor control circuit 410 (FIG. 4) so as to drive the magazine drive motor 333. Thus, the drive gear 313X1 correctly engages a magazine gear 391Y2-1 of the tape cartridge transport magazine 103 (see FIG. 24C) in the same manner as described above. Accordingly, the belt 400 is driven by the magazine drive motor 333 so as to move the tape cartridge containers 401.

When a command to stop driving the tape cartridge transport magazine 103 is input, the magazine drive motor 333 is stopped. Then, the stepping motor 165 is driven in the reverse direction to rotate the turntable 140 back to the home position. Also, the drive shaft unit 301 is moved through the gear member 321 and the rack 305 in the X2 direction back to the home position shown in FIG. 24A.

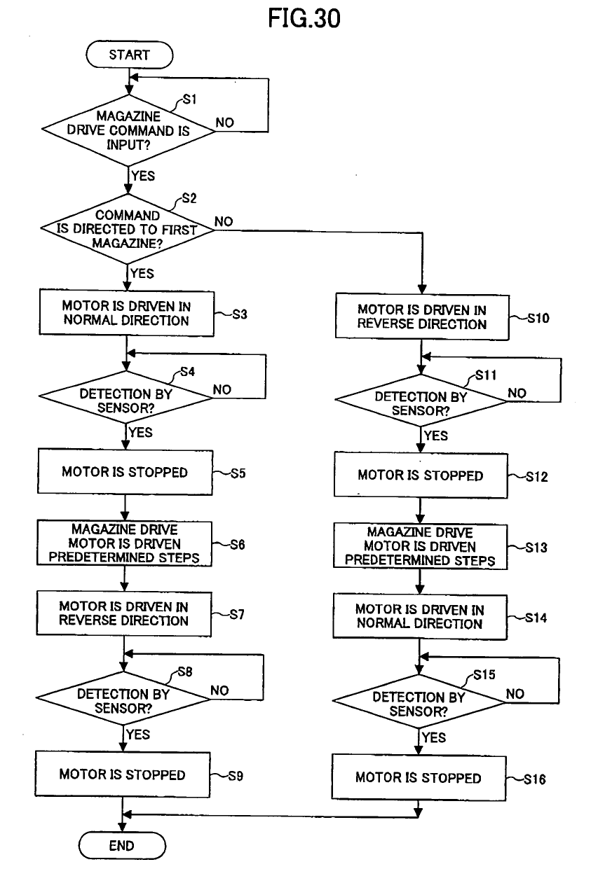

7 [Operations of Microcomputer of Motor Control Circuit 410] (see FIG. 30)

The microcomputer of the motor control circuit 410 operates as illustrated in FIG. 30.

When a magazine drive command is input, the microcomputer determines whether the command is directed to the first media cartridge transport magazine 104 (S1, S2). If the command is directed to the first media cartridge transport magazine 104, the microcomputer drives the stepping motor 165 in the normal direction. When the photo sensor 370 detects that the turntable 140 is rotated approximately 90 degrees, for example, in the counterclockwise direction, the microcomputer stops the stepping motor 165 (S3, S4, S5). After that, the magazine drive motor 333 is driven predetermined steps (S6). The microcomputer then drives the stepping motor 165 in the reverse direction. When the photo sensor 370 detects that the turntable 140 is rotated in the clockwise direction to the home position, the microcomputer stops the stepping motor 165 (S7, S8, S9)

If the command is directed to the second media cartridge transport magazine 103, the microcomputer drives the stepping motor 165 in the reverse direction. When the photo sensor 370 detects that the turntable 140 is rotated 90 degrees in the clockwise direction, the microcomputer stops the stepping motor 165 (S10, S11, S12). After that, the magazine drive motor 333 is driven predetermined steps (S13). The microcomputer then drives the stepping motor 165 in the normal direction. When the photo sensor 370 detects that the turntable 140 is rotated in the counterclockwise direction to the home position, the microcomputer stops the stepping motor 165 (S14, S15, S16).

8 [Configuration and Operations of Tape Cartridge Holding Mechanism of Tape Cartridge Container 401]

As described above, the tape cartridge transport magazines 103 and 104 are configured to transport one or more tape cartridge containers 401 (see FIG. 2) and plural tape cartridge containers 401 (for example, eight) can be connected to the belt 400 therein. Accordingly, the same or a fewer number of the tape cartridges 10 as the disposed number of the tape cartridge containers 401 can be contained in the tape cartridge transport magazines 103 and 104.

The tape cartridge container 401, as described below, is configured to contain different types of the tape cartridges 10 whose shapes are different. According to the present embodiment, the tape cartridge container 401 is configured to selectively store two types of the tape cartridges 10 (hereinafter, referred to as an A type tape cartridge 10A and a B type tape cartridge 10B).

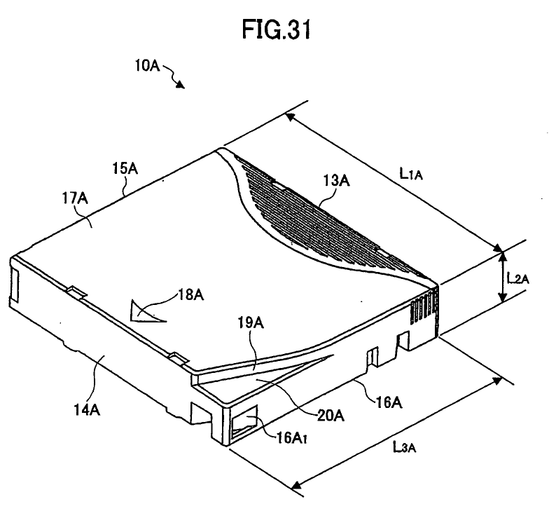

FIG. 31 is a perspective view illustrating a configuration of the A type tape cartridge 10A. As shown in FIG. 31, the tape cartridge 10A has an inserting instruction mark 18A of a triangle on its upper face 17A, and the tape cartridge 10A is inserted into the tape cartridge container 401 starting with its back face 14A from which a tape is drawn. In addition, the tape cartridge 10A includes a recess 20A formed by a slanting section 19A which is slanted by an angle of predetermined degrees for the inserting direction of the tape cartridge 10A at an upper corner of the back face 14A and the side face 16A. Further, in the side face 16A, there is a latching hole 16A₁ which is latched to a latching section of the tape cartridge container 401.

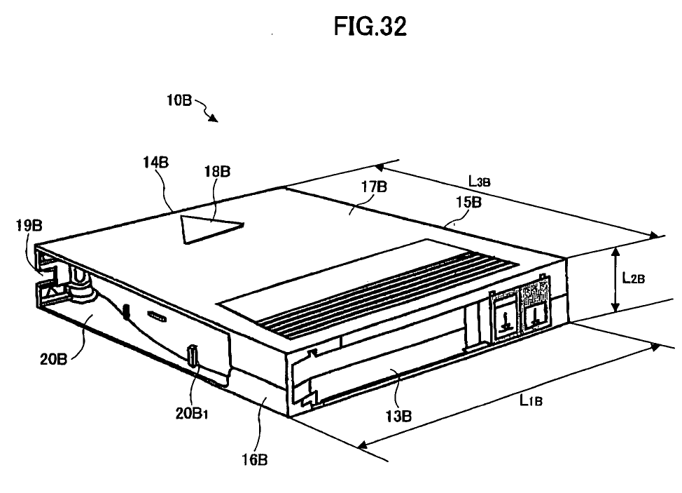

FIG. 32 is a perspective view illustrating a configuration of the B type tape cartridge 10B. As shown in FIG. 32, the tape cartridge 10B has an inserting instruction mark 18B of a triangle on its upper face 17B, and the tape cartridge 10B is inserted into the tape cartridge container 401 starting with its back face 14B from which a tape is drawn. In addition, the tape cartridge 10B provides a recess 20B formed in a side face 16B. Further, a notch 19B connecting to the recess 20B is formed in the back face 14B. In addition, a latching protrusion 20B₁ is formed in the recess 20B and is latched to the tape cartridge container 401 when the tape cartridge 10B is inserted thereinto.

The tape cartridges 10A and 10B are recording media, each recording and reproducing data by a different magnetic recording system. When the shapes and the sizes are compared between them, since for the width L_{1A}=L_{1B}, for the height L_{2A}<L_{2B}, and for the length L_{A3}>L_{B3}, the widths are the same, but the heights and the lengths are different, in one embodiment. In another embodiment, the dimensions of the tape cartridges 10A, 10B can be different than the relative dimensions provided above. Further, the tape cartridge 10A provides the recess 20A and the tape cartridge 10B provides the notch 19B, the recess 20B, and the latching protrusion 20B₁. Accordingly, to contain the tape cartridges 10A and 10B, the tape cartridge container 401 includes a containing space (the width L_{1A}, the height L_{2B}, and the length L_{3A}) corresponding to the larger dimensions of the tape cartridges 10A and 10B.

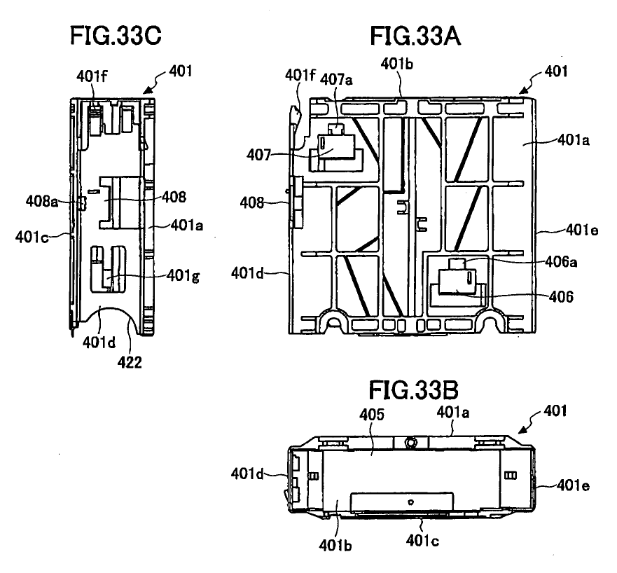

FIGS. 33A-33C illustrate one embodiment of the tape cartridge container 401, wherein FIG. 33A is a plan view, FIG. 33B is a front view, and FIG. 33C is a side view. As shown in FIGS. 33A-33C, the tape cartridge container 401 includes an opening 422 in its front face into which the tape cartridge 10A or 10B is inserted, and a cartridge containing space 405 connecting to the opening 422 of the tape cartridge container 401. The cartridge containing space 405 has the dimensions (the width L_{1A}, the height L_{2B}, and the length L_{3A}) so that both the tape cartridges 10A and 10B can be inserted.

The tape cartridge container 401 is formed by walls (other than the opening 422) surrounding the cartridge containing space 405, and includes an upper plate 401a, a back plate 401b, a bottom plate 401c, and side plates 401d and 401e. In addition, a first latching section 401f for fitting to the latching hole 16A₁ of the tape cartridge 10A is formed at the back plate side of the side plate 401d. Further, a second latching section 401g for latching the tape cartridge 10B is formed at the side plate 401d.

As described below in detail, first and second holding member attaching sections 406 and 407 are disposed at the upper plate 401a. In addition, a third holding member attaching section 408 is disposed at the side plate 401d. Further, latching holes 406a-408a for latching holding members (described below) are formed at the first through third holding member attaching sections 406 through 408.

Next, configurations of first and second cartridge holding members 411 and 412 being elements of tape cartridge holding mechanisms 409A and 409B of the tape cartridge container 401 are explained.

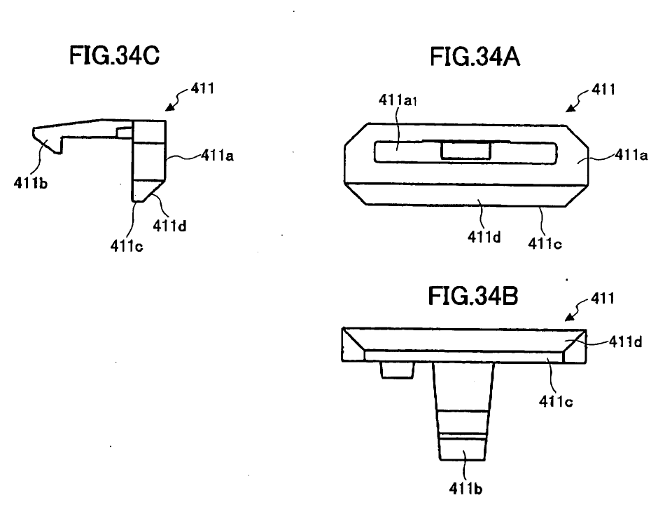

FIGS. 34A-34C illustrate a configuration of the first cartridge holding member 411, wherein FIG. 34A is a front view, FIG. 34B is a bottom view, and FIG. 34C is a side view. As shown in FIGS. 34A-34C, the first cartridge holding member 411 is formed by a resin and includes an abutting section 411a which abuts an end face of the first holding member attaching section 406, a latching section 411b which extends from the abutting section 411a in a substantially perpendicular direction, and a sliding section 411c and a slanting section 411d which are formed at a lower end of the abutting section 411a. A positioning hole 411a₁, into which an end of the first holding member attaching section 406 is fitted is formed in the abutting section 411a.

The first cartridge holding member 411 causes the positioning hole 411aᵢ to fit to an end of the first holding member attaching section 406, and the latching section 411b to fit into the latching hole 406a of the first holding member attaching section 406 so that the first holding member attaching section 406 holds the first cartridge holding member 411. In this state, the first cartridge holding member 411 is attached to the first holding member attaching section 406. As described above, since the first cartridge holding member 411 is attached to the first holding member attaching section 406, the sliding section 411c abuts the upper face 17A (FIG. 31) of the tape cartridge 10A so as to maintain the height and functions as an inhibiting member that inhibits or prevents the tape cartridge 10B from being inserted.

The first cartridge holding member 411 also works as a holding member which is attached to the third holding member attaching section 408. As described below, when the attaching position is changed, the first cartridge holding member 411 guides the insertion of the side face 16B of the tape cartridge 10B, and functions as an inhibiting member that inhibits or prevents the tape cartridge 10A from being inserted.

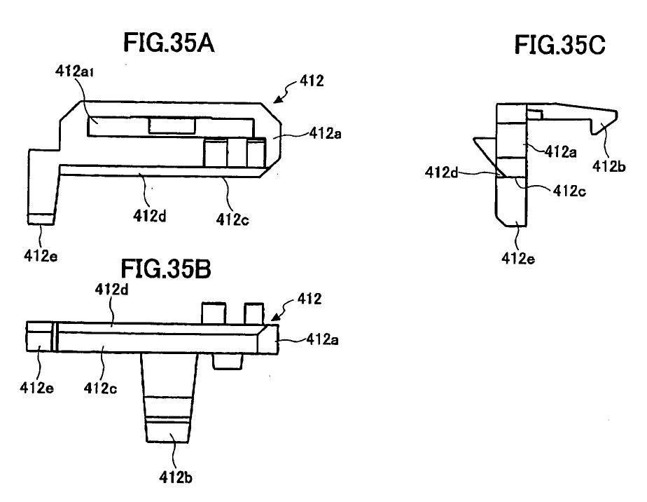

FIGS. 35A-35C illustrate a configuration of the second cartridge holding member 412, wherein FIG. 35A is a front view, FIG. 35B is a bottom view, and FIG. 35C is a side view. As shown in FIGS. 35A-35C, the second cartridge holding member 412 is formed from materials that can be substantially similar to the first cartridge holding member 411, such as a resin, plastic, metal, etc., and includes an abutting section 412a which abuts an end face of the second holding member attaching section 407, a latching section 412b which extends from the abutting section 412a in a substantially perpendicular direction, a sliding section 412c and a slanting section 412d which are formed at a lower end of the abutting section 412a, and a protruding section 412e which extends in the lower direction from a side face of the abutting section 412a. A positioning hole 412a₁ into which an end of the second holding member attaching section 407 is fitted is formed in the abutting section 412a.

The second cartridge holding member 412 causes the positioning hole 412a₁ to fit to an end of the second holding member attaching section 407, and the latching section 412b to fit into the latching hole 407a of the second holding member attaching section 407 so that the second holding member attaching section 407 holds the second cartridge holding member 412.

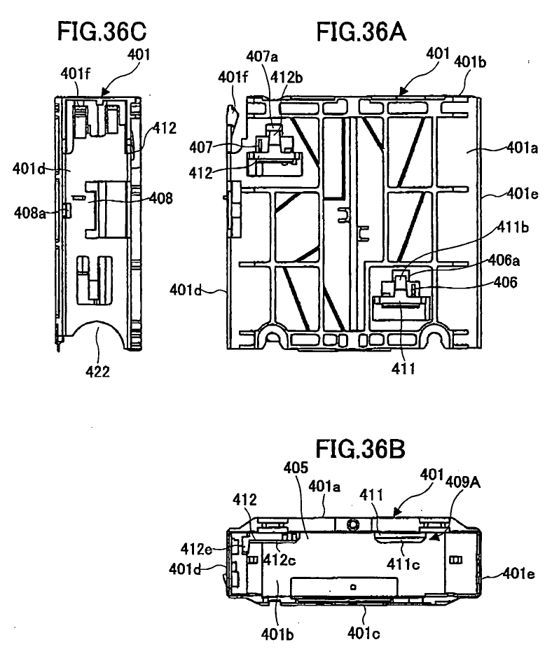

Next, attaching states of the first and second cartridge holding members 411 and 412 are explained. First, with reference to FIGS. 36A-36C, a configuration of a case in which the tape cartridge 10A can be inserted is explained. As shown in the embodiment illustrated in FIGS. 36A-36C, when the tape cartridge container 401 is used for the tape cartridge 10A, both of the first and second cartridge holding members 411 and 412 being the elements of the tape cartridge holding mechanism 409A are attached to the tape cartridge container 401. That is, the first cartridge holding member 411 is horizontally attached to the first holding member attaching section 406 of the tape cartridge container 401, and the second cartridge holding member 412 is horizontally attached to the second holding member attaching section 407 of the tape cartridge container 401. The first cartridge holding member 411 fits the latching section 411b into the latching hole 406a of the first holding member attaching section 406, and the second cartridge holding member 412 fits the latching section 412b into the latching hole 407a of the second holding member attaching section 407 so that the first and second cartridge holding members 411 and 412 do not drop.

Since the first and second cartridge holding members 411 and 412 are latched to the upper plate 401a, the sliding sections 411c and 412c extend from the upper plate 401a in the cartridge containing space 405. The distance between these sliding sections 411c and 412c and the bottom plate 401c is slightly larger than the height L_{2A} of the tape cartridge 10A. Consequently, the tape cartridge 10A can be inserted into the cartridge containing space 405 allowed by the heights of the sliding sections 411c and 412c of the first and second cartridge holding members 411 and 412.

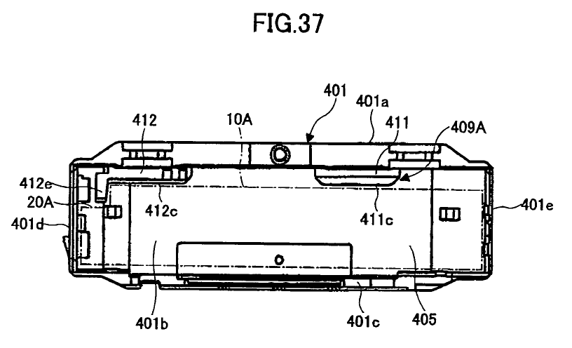

As shown in FIG. 37, when a selected tape cartridge 10A (shown by an alternate long and short dash line) is inserted into the cartridge containing space 405, the upper face 17A (FIG. 31) of the tape cartridge 10A slides on the sliding sections 411c and 412c and the tape cartridge 10A is held without excessive movement in the up and down directions. Further, the recess 20A formed by the slanting section 19A which is formed at the inserting upper face side of the tape cartridge 10A moves toward the protruding section 412e of the second cartridge holding member 412. When inserting the tape cartridge 10A into the cartridge containing space 405 is completed, the first latching section 401f of the tape cartridge container 401 is fitted into the latching hole 16A₁ of the tape cartridge 10A, and the tape cartridge 10A is latched.

When the tape cartridge 10A is inserted in a wrong direction (an upside down direction or a reversed direction of the back face 14A and the front face 13A, for example), the protruding section 412e of the second cartridge holding member 412 abuts a position other than the recess 20A of the tape cartridge 10A, and the tape cartridge 10A cannot be moved further and is inhibited or prevented from being inserted.

In addition, in the tape cartridge container 401 configured for the tape cartridge 10A, the tape cartridge 10B whose height is greater than that of the tape cartridge 10A can be inhibited or prevented from being inserted. Consequently, mis-inserting of the tape cartridge 10B into the tape cartridge container 401 for the tape cartridge 10A can be inhibited.

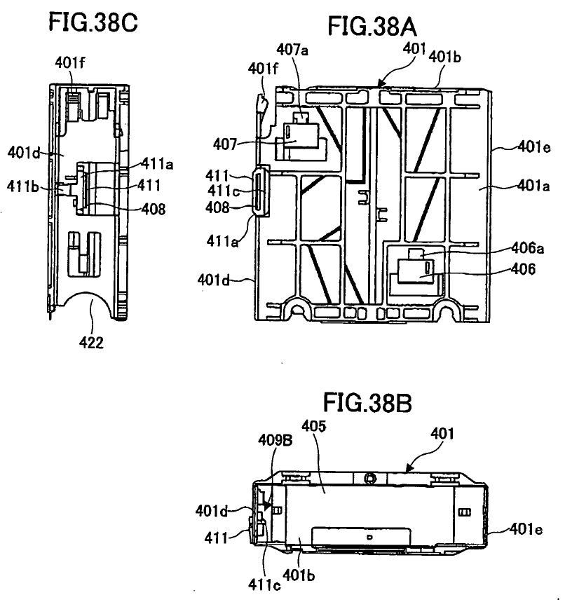

Next, with reference to FIGS. 38A-38C, a configuration of a case in which the tape cartridge 10B can be inserted is explained. When the tape cartridge container 401 is used for the tape cartridge 10B, only the first cartridge holding member 411 being an element of the tape is cartridge holding mechanism 409B is attached to the tape cartridge container 401. That is, in this embodiment, the first cartridge holding member 411 is vertically attached to the third holding member attaching section 408 of the tape cartridge container 401 in a manner so that the latching section 411b faces downward. The first cartridge holding member 411 fits the latching section 411b into the latching hole 408a of the third holding member attaching section 408 so that the first cartridge holding member 411 does not drop.

In this case, since the latching section 411b of the first cartridge holding member 411 extends downward for the side plate 401d of the tape cartridge container 401, the sliding section 411c extends into the cartridge containing space 405. Accordingly, the first cartridge holding member 411 is attached to the tape cartridge container 401 in a state so that the sliding section 411c extends toward the side face 16B of the tape cartridge 10B.

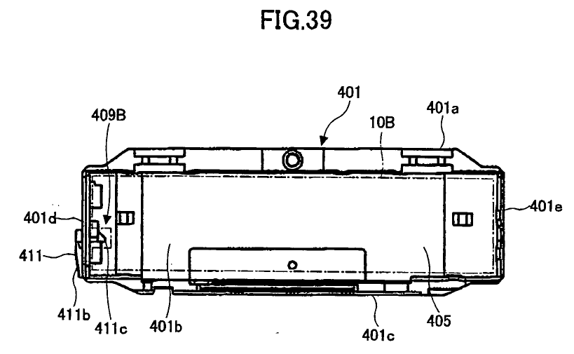

As shown in FIG. 39, when a selected tape cartridge 10B (shown by an alternate long and short dash line) is inserted into the cartridge containing space 405, the tape cartridge 10B can be inserted in the cartridge containing space 405 so that the sliding section 411c of the first cartridge holding member 411 does not obstruct the way due to the notch 19B of the tape cartridge 10B. When inserting the tape cartridge 10B into the cartridge containing space 405 is completed, the second latching section 401g of the tape cartridge container 401 which is passed through the notch 19B latches the latching protrusion 20B₁, and the tape cartridge 10B is latched.

However, when the tape cartridge 10A different from the selected tape cartridge 10B is inserted into the tape cartridge container 401, the sliding section 411c of the first cartridge holding member 411 abuts the back face 14A of the tape cartridge 10A, and mis-inserting of the tape cartridge 10A can be inhibited or prevented.

In addition, when the tape cartridge 10B is inserted in a wrong direction (an upside down direction or a reversed direction of the back face 14B and the front face 13B, for example), the sliding section 411c of the first cartridge holding member 411 abuts a position other than the notch 19B of the tape cartridge 10B, and the tape cartridge 10B cannot be moved further and can be inhibited from being inserted.

As described above, the present embodiment provides two configurations, that is, in a first configuration, the first cartridge holding member 411 is attached to the first holding member attaching section 406 of the tape cartridge container 401 and the second cartridge holding member 412 is attached to the second holding member attaching section 407 of the tape cartridge container 401; and in a second configuration, the first cartridge holding member 411 is attached to the third holding member attaching section 408 of the tape cartridge container 401. Therefore, the tape cartridge 10A and the tape cartridge 10B which are different from each other can be selectively inserted into the tape cartridge container 401. Accordingly, the tape cartridge container 401 can be common between the tape cartridges 10A and 10B, and the manufacturing cost of the autoloader 100 can be reduced. Further, since the first cartridge holding member 411 can be used in common in the two configurations, the number of components can be reduced.

The present application is based on Japanese Priority Application No. 2005-267534 filed on Sep. 14, 2005, with the Japanese Patent Office, the entire contents of which are hereby incorporated by reference.

While the particular autoloader 100 as herein shown and disclosed in detail is fully capable of obtaining the objects and providing the advantages herein before stated, it is to be understood that it is merely illustrative of various embodiments of the invention. No limitations are intended to the details of construction or design herein shown other than as described in the appended claims.

What is claimed is:

1. A media cartridge autoloader that comprises a plurality of media cartridge containers each of which may contain an inserted media cartridge, a media cartridge transport magazine which movably holds the plural media cartridge containers, and a media drive into which an arbitrary media cartridge, which is picked from the plural media cartridges being contained in the plural media cartridge containers, is moved and loaded;
wherein the media cartridge container is formed to provide a space into which any one of the plural media cartridges whose sizes are different is inserted, and the media cartridge container provides a media cartridge holding mechanism which holds a specific media cartridge of the plural media cartridges.

2. The media cartridge autoloader as claimed in claim 1,
wherein the media cartridge holding mechanism provides a cartridge holding member which is attached to a position abutting on different parts in the plural media cartridges, and a media cartridge whose shape is not suitable to the position where the cartridge holding member is attached is prevented from being inserted into the media cartridge container.

3. The media cartridge autoloader as claimed in claim 2,
wherein the cartridge holding member is attached to a different position of the media cartridge container corresponding to the shape of a selected media cartridge.

4. The media cartridge autoloader as claimed in claim 2,
wherein the cartridge holding member includes a first cartridge holding member which holds an upper face of the media cartridge and a second cartridge holding member which holds the upper face and a side face of the media cartridge, and only a media cartridge having a selected shape may be inserted into the media cartridge container by combining the first cartridge holding member and the second cartridge holding member.

5. The media cartridge autoloader as claimed in claim 2,
wherein the cartridge holding member holds a different type of the plural media cartridges by changing the position attaching to the media cartridge container.

6. A media cartridge transport magazine for a media cartridge autoloader that is adapted for use with a first media cartridge having a first size and a second media cartridge having a second size that is different than the first size, the media cartridge autoloader including a media drive that receives one of the media cartridges and a media cartridge picker that selectively moves the media cartridges relative to the media cartridge transport magazine, the media cartridge transport magazine comprising:
a media cartridge container that transportably stores one of the media cartridges, the media cartridge container having a containing space that alternately receives the first media cartridge and the second media cartridge; and
a cartridge holding mechanism that is movably positioned within the containing space in a first position that inhibits full insertion of the first media cartridge into the container space, and a second position that inhibits full insertion of the second media cartridge into the container space.

7. The media cartridge transport magazine as claimed in claim 6,
wherein in the first position, the cartridge holding mechanism allows full insertion of the second media cartridge into the container space.

8. The media cartridge transport magazine as claimed in claim 7,
wherein in the second position, the cartridge holding mechanism allows full insertion of the first media cartridge into the container space.

9. The media cartridge transport magazine as claimed in claim 6,
wherein in the first position, the cartridge holding mechanism abuts a portion of the second media cartridge to inhibit full insertion of the second media cartridge into the container space, and in the second position, the cartridge holding mechanism abuts a portion of the first media cartridge to inhibit full insertion of the first media cartridge into the container space.

10. The media cartridge transport magazine as claimed in claim 6,
wherein the cartridge holding mechanism is attached to a different position within the tape cartridge container depending upon which media cartridge is to be allowed full insertion into the container space.

11. The media cartridge transport magazine as claimed in claim 6,
wherein in the first position, the cartridge holding mechanism abuts the first media cartridge upon full insertion of the first media cartridge into the container space to releasably retain the first media cartridge within the container space.

12. The media cartridge transport magazine as claimed in claim 11,
wherein in the second position, the cartridge holding mechanism abuts the second media cartridge upon full insertion of the second media cartridge into the container space to releasably retain the second media cartridge within the container space.

13. A method for configuring a media cartridge autoloader that is adapted for use with a first media cartridge having a first size and a second media cartridge having a second size that is different than the first size, the method comprising the steps of:
configuring a containing space of a media cartridge container that transportably stores one of the media cartridges so that the containing space alternately receives the first media cartridge and the second media cartridge; and
alternately positioning a cartridge holding mechanism within the containing space in a first position that inhibits full insertion of the first media cartridge into the container space and a second position that inhibits full insertion of the second media cartridge into the container space.

14. The method as claimed in claim 13, wherein in the first position, the cartridge holding mechanism allows full insertion of the second media cartridge into the container space.

15. The method as claimed in claim 14, wherein in the second position, the cartridge holding mechanism allows full insertion of the first media cartridge into the container space.
